(19) United States
(12) Patent Application Publication
(10) Pub. No.: US 2025/0245986 A1
(43) Pub. Date: Jul. 31, 2025

(54) SCENE RECOGNITION

(71) Applicant: TENCENT TECHNOLOGY (SHENZHEN) COMPANY LIMITED, Shenzhen (CN)

(72) Inventor: Hao SONG, Shenzhen (CN)

(73) Assignee: TENCENT TECHNOLOGY (SHENZHEN) COMPANY LIMITED, Shenzhen (CN)

(21) Appl. No.: 19/173,728

(22) Filed: Apr. 8, 2025

Related U.S. Application Data
(63) Continuation of application No. PCT/CN2024/076194, filed on Feb. 6, 2024.

(30) Foreign Application Priority Data
Mar. 21, 2023 (CN) 202310318822.3

(51) Int. Cl. G06V 20/40; G06F 11/3604; G06V 10/26; G06V 10/34; G06V 10/74

(52) U.S. Cl. CPC G06V 20/40; G06F 11/3612; G06V 10/26; G06V 10/34; G06V 10/74

(57) ABSTRACT

Some aspects of the disclosure provide a method of scene recognition. In some examples, a first video that includes interface images of a computer device recorded when an application program is executed on the computer device can be obtained. A first interface image is extracted from the first video, the first interface image includes a first interface element area with one or more preset interface elements of the application program, and a first background area excluding the first interface element area. A first background structure feature of the first background area in the first interface image is determined. Whether the first background structure feature satisfies a matching condition to a second background structure feature of a preset scene is determined. The first interface image is determined to correspond to the preset scene when the first background structure feature satisfies the matching condition to the second background structure feature.

### RELATED APPLICATIONS

The present application is a continuation of International Application No. PCT/CN2024/076194, filed on Feb. 6, 2024, which claims priority to Chinese Patent Application No. 202310318822.3, filed on Mar. 21, 2023. The entire disclosures of the prior applications are hereby incorporated by reference.

### FIELD OF THE TECHNOLOGY

Embodiments of this application relate to the field of computer and Internet technologies, including scene recognition.

### BACKGROUND OF THE DISCLOSURE

Currently, scene recognition of an application program is widely applied to various fields. For example, in the field of automated assertion, the scene recognition may determine whether assertion succeeds or fails by recognizing whether a scene of assertion success occurs.

In related art, a scene recognition method of an application program is provided, and the scene recognition may be performed by using a trained artificial intelligence (AI) model.

However, the scene recognition method of the application program in the related art is limited in scene recognition capacity in various aspects such as training samples, models, and training algorithms, and cannot recognize a complex scene accurately.

### SUMMARY

According to embodiments of this disclosure, a scene recognition method and apparatus of an application program, a device, and a storage medium are provided.

Some aspects of the disclosure provide a method of scene recognition. In some examples, a first video that includes interface images of a computer device recorded when an application program is executed on the computer device can be obtained. A first interface image is extracted from the first video. The first interface image includes a first interface element area with one or more preset interface elements of the application program, and a first background area excluding the first interface element area. A first background structure feature of the first background area in the first interface image is determined. Whether the first background structure feature satisfies a matching condition to a second background structure feature of a preset scene is determined. The first interface image is determined to correspond to the preset scene when the first background structure feature satisfies the matching condition to the second background structure feature.

Some aspects of the disclosure provide an information processing apparatus that includes processing circuitry. The processing circuitry can obtain a first video that includes interface images of a computer device that are recorded when an application program is executed on the computer device, and extract a first interface image from the first video. The first interface image includes a first interface element area with one or more preset interface elements of the application program, and a first background area excluding the first interface element area. The processing circuitry can determine a first background structure feature of the first background area in the first interface image, determine whether the first background structure feature satisfies a matching condition to a second background structure feature of a preset scene, and determine that the first interface image corresponds to the preset scene when the first background structure feature satisfies the matching condition to the second background structure feature.

In an aspect, a scene recognition method of an application program is provided, and performed by a computer device, and the method includes:
obtaining a first video obtained by recording an interface of an application program;
extracting a first interface image from the first video, the first interface image including a first interface element area in which a preset interface element of the application program is located, and further including a first background area except the first interface element area;
determining a first background structure feature of the first interface image in the first background area;
obtaining a second background structure feature of the interface in a preset scene;
judging whether the first background structure feature and the second background structure feature meet a preset matching condition; and
determining that the interface recorded in the first interface image is in the preset scene when the first background structure feature and the second background structure feature meet the preset matching condition.

In one aspect, a scene recognition apparatus of an application program is provided, and the apparatus includes:
an interface image obtaining module, configured to obtain a first video obtained by recording an interface of an application program; and extract a first interface image from the first video, the first interface image including a first interface element area in which a preset interface element of the application program is located, and further including a first background area except the first interface element area;
a first determining module, configured to determine a first background structure feature of the first interface image in the first background area;
a preset scene background structure feature obtaining module, configured to obtain a second background structure feature of the interface in a preset scene; and
a second determining module, configured to judge whether the first background structure feature and the second background structure feature meet a preset matching condition; and determine that the interface recorded in the first interface image is in the preset scene when the first background structure feature and the second background structure feature meet the preset matching condition.

In one aspect, a computer device is provided, including a processor (e.g., processing circuitry) and a memory, the memory having a computer program stored therein, the processor being configured to execute the computer program to implement the foregoing scene recognition method of the application program.

In one aspect, a computer-readable storage medium (such as a non-transitory computer-readable storage medium) is provided, the computer-readable storage medium having a computer program stored therein, the computer program being loaded and executed by a processor to implement the foregoing scene recognition method of the application program.

In one aspect, a computer program product is provided, including a computer program, the computer program being loaded and executed by a processor to implement the foregoing scene recognition method of the application program.

Details of one or more embodiments of this disclosure are provided in the accompanying drawings and descriptions below. Other features, objectives, and advantages of this disclosure become apparent from the specification, the drawings, and the claims.

### BRIEF DESCRIPTION OF THE DRAWINGS

FIG. 1 is a schematic diagram of a solution implementation environment according to an embodiment of this disclosure.

FIG. 2 is a flowchart of a scene recognition method of an application program according to an embodiment of this disclosure.

FIG. 3 is a schematic diagram of framing according to an embodiment of this disclosure.

FIG. 4 is a schematic diagram of area division according to an embodiment of this disclosure.

FIG. 5 is a schematic diagram of a plurality of area division manners according to an embodiment of this disclosure.

FIG. 6 is a schematic diagram of a same-color through line according to an embodiment of this disclosure.

FIG. 7 is a flowchart of a scene recognition method of an application program according to another embodiment of this disclosure.

FIG. 8 is a block diagram of a scene recognition apparatus of an application program according to an embodiment of this disclosure.

FIG. 9 is a block diagram of a scene recognition apparatus of an application program according to another embodiment of this disclosure.

FIG. 10 is a structural block diagram of a computer device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

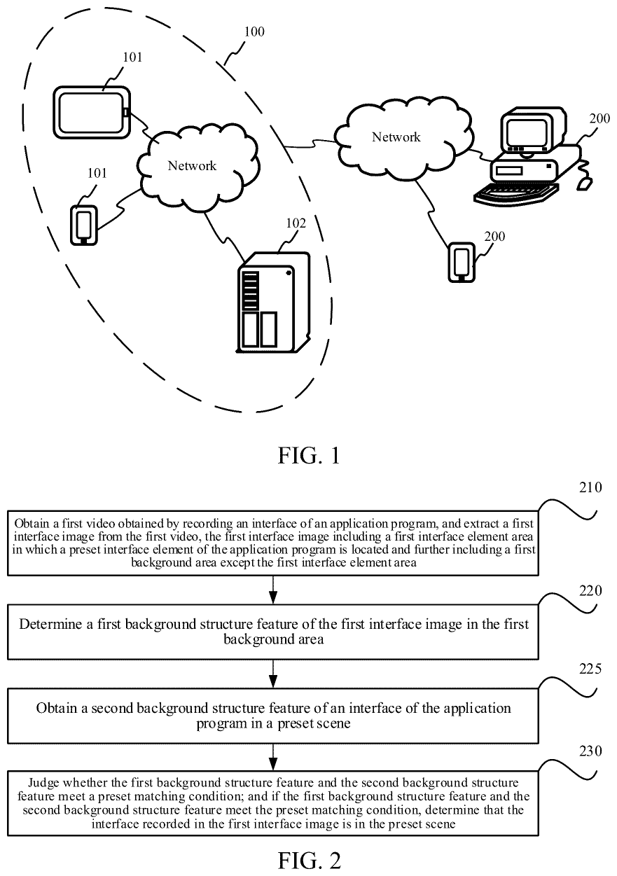

FIG. 1 is a schematic diagram of a solution implementation environment according to an embodiment of this disclosure. The solution implementation environment may be implemented as a system architecture of scene recognition of an application program. The solution implementation environment may include: a recognition device 100 and an acquisition device 200.

The recognition device 100 is configured to recognize an interface image, and determine whether an interface recorded in the interface image is located in a preset scene. The recognition device 100 may be a computer device, and the computer device may be a terminal device 101 or may be a server 102. This is not limited in this disclosure. The terminal device 101 may be an electronic device such as a personal computer (PC), a tablet computer, a mobile phone, a wearable device, or a vehicle-mounted terminal.

The server 102 may be an independent physical server, or may be a server cluster including a plurality of physical servers or a distributed system, or may be a cloud server that provides a cloud computing service. The server 200 may be a backend server of a target application program, and is configured to provide backend services for clients of the target application program.

The acquisition device 200 is configured to obtain a first video obtained by recording an interface of the application program, and extract a first interface image from the first video. The acquisition device 200 may be a terminal device. The terminal device may be an electronic device such as a personal computer (PC), a tablet computer, a mobile phone, a wearable device, or a vehicle-mounted terminal. A client running the above application program may be installed in the acquisition device 200. A type of the application program is not limited in this disclosure. For example, the application program may be a life service application program, a sports application program, a social application program, or the like. In addition, a form of the application program is not limited in this disclosure, and includes, but is not limited to an application program (APP), a mini program, and the like that are installed in the terminal device 100, or may be in a form of a web page.

The recognition device 100 and the acquisition device 200 may communicate with each other through a network, such as a wired or wireless network.

In the scene recognition method of the application program provided in the embodiments of this disclosure, an execution body of each operation may be the computer device. The computer device is an electronic device with a data computing capability, a data processing capability, and a data storage capability. Using the solution implementation environment shown in FIG. 1 as an example, the scene recognition method of the application program may be performed by the recognition device 100 (for example, the scene recognition method of the application program may be performed by the terminal device 101, or the scene recognition method of the application program may alternatively be performed by the server 102), or may be performed by the acquisition device 200 and the recognition device 100 in cooperation with each other. This is not limited in this disclosure. For ease of description, in the following method embodiments, description is only provided by using an example in which the execution body of each operation in the scene recognition method of the application program is the computer device.

In the related art, two scene recognition methods of the application program are provided. Method I: template matching detection and feature matching detection are performed on an interface image based on a preset template picture having a background structure feature of a preset scene, to implement the scene recognition of the application program. Method II: scene recognition is performed on the interface image based on a trained AI model, to determine whether an interface element area belongs to an interface of the preset scene. The interface image corresponds to the interface element area of the application program.

However, in the foregoing method I, template matching detection has a great limitation. Specifically, only parallel translation can be performed, and if a matching target undergoes rotation and size changes, an algorithm fails to recognize the scene. An operating speed of feature matching detection is low, and even in a local high-priority determining manner, the speed bottleneck is still difficult to break through.

In the method II, the AI model has relatively large limitations to complex scene analysis, gradual-fading and gradual-occurrence interference, and engineering automation.

An embodiment of this disclosure provides a scene recognition method of an application program. A first video obtained by recording an interface of the application program is obtained, and a first interface image is extracted from the first video; a first background structure feature of the first interface image is determined in a first background area of the first interface image; and when the first background structure feature and a second background structure feature of the interface of the application program in the preset scene meet a preset matching condition, it is determined that the interface recorded in the first interface image is in the preset scene. The scene recognition method may be applicable to interface images obtained by using different platforms and different models. A complex feature extraction process is not needed, thereby improving a scene recognition speed of the application program.

FIG. 2 is a flowchart of a scene recognition method of an application program according to an embodiment of this disclosure. This embodiment is described by using an example in which the method is applied to a computer device. To be specific, the method is performed by the computer device. The method may include at least one operation of Operation 210 to Operation 230 below.

Operation 210: Obtain a first video obtained by recording an interface of an application program, and extract a first interface image from the first video, the first interface image including a first interface element area in which a preset interface element of the application program is located and further including a first background area except the first interface element area.

The first video is a video on which scene recognition needs to be performed, and the first video is obtained by recording the interface of the application program. The first video may be obtained by recording an interface change process in a process of interface change of the application program. The first video may be obtained by starting, by a user, screen recording on the computer device, and operating the application program on the computer device to cause the interface of the application program to change, recording the change of the interface during the operation by using the computer device until a recording stop condition is met. In other embodiments, the first video may alternatively be obtained by, one computer device, recording an interface of an application program exhibited by another computer device.

The application program may be a system application program installed in the computer device, or may be a third-party application program installed in the computer device. This is not limited in this disclosure. The system application program is built in an operating system of the computer device, and the third-party application program is provided by a third-party developer on the computer device. The third-party developer is other application program developers than a developer of the operating system.

The interface image includes the interface of the application program. The first interface image is extracted from the first video and includes the interface of the application program. The interface of the application program may be any interface in the application program. For example, the interface may be a startup interface of the application program, or may be a functional interface of the application program, such as a commodity browsing interface, a shopping cart interface, or a chat interface.

The interface image includes an interface element area in which the preset interface element of the application program is located, and further includes a background area except the interface element area. The preset interface element is a preset element constituting the interface, and may include at least one of a picture, text, an animation, or a control displayed in the interface element area. The background area is all or some areas except the interface element area in the interface image, such as an edge line of an independent area, an isolated line or isolated area of an adjacent area, or a decorative shape in the interface. The first interface element area refers to an interface element area in the first interface image, and the first background area refers to a background area in the first interface image.

The computer device may perform framing on the first video, and use each image, including the interface of the application program and obtained by framing as the first interface image, or may sample the first video at a time interval or a video frame interval to obtain a video frame image, and then may determine the video frame image including the interface of the application program from the sampled video frame image as the first interface image.

Operation 220: Determine a first background structure feature of the first interface image in the first background area.

The background structure feature is configured for representing a structure of the background area. To be specific, the background structure feature is configured for describing a structure of the background area of the interface image. The background structure feature may be a structure formed by a color, a shape, brightness, a relative position relationship, or the like of elements in the background area. The first background structure feature refers to a background structure feature of the first interface image.

In some embodiments, an image analysis algorithm may be used for determining the background structure feature of the interface image. The specific image analysis algorithm is not limited in this disclosure.

For example, the color may be used as the background structure feature of the interface image to describe the structure of the background area of the interface image. The brightness may alternatively be used as the background structure feature of the interface image to describe the structure of the background area of the interface image. Alternatively, a same-color through line may be configured for representing the background structure feature of the interface image.

In some embodiments, the scene recognition method of the application program further includes: A first background area of a first interface image is determined according to the first interface image. A method for determining the background area of the first interface image is not limited in this disclosure. For example, binarization processing may be performed on the first interface image to obtain a binary image, and the first background area of the first interface image is determined from the binary image. The binarization processing can enhance a difference between the preset interface element and the background area in the interface image, so that the background area of the interface image can be recognized better.

For example, contour extraction may be performed on the first interface image, to obtain a contour image of the first interface image, and the first background area of the first interface image is determined according to the contour image of the first interface image. The contour image of the first interface image displays a contour of the preset interface element of the interface image, and the first background area of the first interface image may be determined according to contour lines displayed in the contour image of the first interface image. For example, an area outside a circle of the contour lines is the background area of the interface image.

In some embodiments, the operation in which a first background area of the first interface image is determined according to the first interface image includes: the first interface image is binarized to obtain the binary image; a contour of the binary image is extracted to obtain a contour image; a contour of the preset interface element in the contour image is determined; and the first background area except the preset interface element in the first interface image is determined according to the contour of the preset interface element in the contour image. In this embodiment, the binary image obtained by binarization can better represent the difference between the preset interface element and the background area, so that a boundary of the preset interface element in the binary image can be determined more accurately. Because the binary image is obtained by binarizing the first interface image, and the binary image and the first interface image have consistent area distribution, the boundary of the preset interface element in the first interface image can be determined according to the contour of the preset interface element in the contour image, so that the area except the preset interface element in the first interface is determined as the first background area.

For example, the preset interface element included in the first interface image may be recognized, and the area except the preset interface element in the first interface image is determined as the first background area of the first interface image. This disclosure does not limit a method for recognizing the preset interface element included in the first interface image. For example, the preset interface element included in the first interface image may be recognized by an AI model.

By using the foregoing method, the first background area of the first interface image can be better determined, and then the first background structure feature of the first interface image is determined from the first background area of the first interface image.

Operation 225: Obtain a second background structure feature of the interface of the application program in the preset scene.

A scene refers to a particular function that can be implemented by an operation of the interface of the application program. For example, a function implementing shopping by using the interface is a shopping scene. A session function implementing instant messaging by means of an operation of the interface is an instant messaging session scene. A red pack interaction function implementing transmission and receiving of a pack by means of an operation of the interface is a red pack interaction scene. The preset scene needs to be recognized. To be specific, the preset scene is known, and whether the interface recorded by the first interface image is in the preset scene needs to be recognized.

The second background structure feature is possessed by the interface of the application program in the preset scene. The second background structure feature may be preset for the preset scene, or may be calculated in real time when needed. The application program of the interface to which the second background structure feature belongs may be the same as or different from the application program to which the interface in the first interface image belongs.

In some embodiments, the second background structure feature of the preset scene is obtained according to the second interface image of the preset scene.

In some embodiments, operation 225 includes: a second interface image of the preset scene is obtained; the second interface image includes a second interface element area in which the preset interface element of the application program is located, and further includes a second background area except the second interface element area; and a second background structure feature of the second interface image is determined in the second background area.

In some embodiments, various methods for determining the second background structure feature of the preset scene may be the same as or different from various methods for determining the background structure feature of the interface image. This is not limited in this disclosure. Various methods may include: a method for determining the background area of the interface image, and a method for determining the background area of the second interface image.

In some embodiments, a representation method of the background structure feature of the interface image is the same as that of the background structure feature of the preset scene. For example, if the background structure feature of the preset scene is represented by using a through line, the background structure feature of the interface image is represented by using the through line. For example, if the background structure feature of the preset scene is represented by using a color of a specified subarea, the background structure feature of the interface image is represented by using the color of the corresponding specified subarea.

Operation 225 may be performed at any operation before operation 230, for example, may be performed before operation 210, or may be performed after operation 220 and before operation 230.

Operation 230: Judge whether the first background structure feature and the second background structure feature meet a preset matching condition; and when the first background structure feature and the second background structure feature meet the preset matching condition, determine that the interface recorded in the first interface image is in the preset scene.

The matching condition is a judging condition for judging whether the interface in the first interface image belongs to the preset scene at a level of the background structure feature. The matching condition is specifically related to the second background structure feature. The quantity of the second background structure feature may be one or more, and each second background structure feature corresponds to at least one matching condition.

If the first background structure feature and the second background structure feature meet the preset matching condition, namely, the first background structure feature matches the second background structure feature, it is determined that the interface recorded in the first interface image is in the preset scene. If the first background structure feature and the second background structure feature do not meet the preset matching condition, namely, the first background structure feature does not match the second background structure feature, it is determined that the interface recorded in the first interface image is not in the preset scene.

In some embodiments, the preset matching condition includes: The first background structure feature is the same as the second background structure feature. In this embodiment, in a case that the first background structure feature is the same as the second background structure feature, it is determined that the interface in the first interface image is in the preset scene. In a case that the first background structure feature is different from the second background structure feature, it is determined that the interface in the first interface image is not in the preset scene.

In some embodiments, the preset matching condition includes: at least one first background structure feature of the plurality of first background structure features is the same as at least one second background structure feature of the plurality of second background structure features.

In some embodiments, the operation in which whether the first background structure feature and the second background structure feature meet a preset matching condition is judged includes: a matching degree between the first background structure feature and the second background structure feature is calculated, and whether the matching degree exceeds a preset matching degree threshold is determined. When the matching degree exceeds the preset matching degree threshold, it may be determined that the first background structure feature and the second background structure feature meet the preset matching condition. The matching degree may be represented by using a similarity between the first background structure feature and the second background structure feature. For different types of background structure features, a suitable similarity calculation manner may be used. For example, a Euclidean distance or a cosine similarity may be used as the matching degree.

According to the technical solution provided in this embodiment of this disclosure, the background structure feature of the interface image is extracted in the background area of the interface image, and feature matching detection is performed on the background structure feature of the interface image and the background structure feature of the preset scene, to determine whether the interface element area belongs to the interface of the preset scene. The processing is performed based on a simple image analysis algorithm without complex feature extraction operations, so that time required for the scene recognition of the application program is reduced. A good effect may further be achieved for the complex scene analysis. In addition, the scene recognition based on the background structure feature may be applicable to images obtained by different platforms and different models.

In some embodiments, operation 225 includes at least one operation of operation 240 to operation 250:

Operation 240: Obtain a second interface image in the preset scene, the second interface image including a second interface element area in which the preset interface element of the application program is located, and further including a second background area except the second interface element area.

The second interface image is a known interface image in the preset scene, and has a source different from that of the first interface image. The second interface image is constituted the same as that of the first interface image, and alternatively includes an interface element area and a background area, which are respectively referred to as a second interface element area and a second background area for being distinguished from the interface element area and the background area of the first interface image. The second interface image records the interface in the preset scene. In some embodiments, the second interface image may be obtained by taking a screenshot of the interface of the application program.

In some embodiments, the second interface image of the preset scene may have a same size as or a different size from that of the interface image. This is not limited in this disclosure. For example, the second interface image and the interface image of the preset scene may be from computer devices of different models and have different sizes. The application program of the interface recorded in the second interface image may be the same as or different from the application program of the interface recorded in the first interface image.

In some embodiments, a length-width ratio of the second interface image in the preset scene is equal to a length-width ratio of the first interface image, or a difference between the length-width ratio of the second interface image of the preset scene and the length-width ratio of the first interface image is less than a preset threshold. In this embodiment, in a case that the interface recorded by the first interface image is in the preset scene, compared with the interface recorded by the first interface image, content exhibited by the second interface image of the preset scene is the same or slightly different.

In some embodiments, the second interface image in the preset scene may be extracted from a video including the interface of the preset scene. Further, the second interface image in the preset scene may be extracted from a second video obtained by recording the interface of the application program in the preset scene.

In some embodiments, the operation in which a second interface image in the preset scene is obtained includes: the second video obtained by recording the interface of the application program in the preset scene is obtained (e.g., the second video includes second interface images that are recorded when a standard execution of the application program in the preset scene occurs); a starting video frame image in the preset scene is selected from the second video; and the starting video frame image is used as the second interface image in the preset scene. In this embodiment, the second video may be framed, to obtain a plurality of video frame images, and a first video frame image in which the preset scene occurs is selected from the plurality of video frame images as the second interface image of the preset scene. The starting video frame image is a video frame image that can represent the preset scene. When the second video changes from a video frame image without recording the interface in the preset scene to a video frame image recording the interface in the preset scene, a transitional video frame image in a change process does not belong to the starting video frame image.

For example, as shown in FIG. 3, the second video is framed to obtain a plurality of video frame images, and a starting video frame image 310 in which the preset scene occurs is selected from the plurality of video frame images as the second interface image of the preset scene.

In some embodiments, another video frame image in the preset scene may alternatively be selected from the second video. Specifically, candidate video frame images in the preset scene may be determined from various video frame images of the second video. Subsequently, a background area in each candidate video frame image is determined, and then a degree of prominence of the background structure feature of the background area in each video frame image is determined. Finally, the video frame image in which the degree of prominence of the background structure feature meets a preset screening condition is selected as the second interface image in the preset scene.

The degree of prominence of the background structure feature may be obtained by performing quantization mapping on the background structure feature in the candidate video frame image. For example, a color value, a brightness value, a line width, and whether a line is located in a preset position may be quantized and mapped to a numerical value, normalized to a uniform value range, and then aggregated (such as, summation or weighted summation), to obtain the degree of prominence of the background structure feature. The degree of prominence of the background structure feature may alternatively be a similarity between the background structure feature of the video frame image and the preset background structure feature. A higher similarity indicates a higher degree of prominence of the background structure feature.

In this embodiment, the video frame image having a distinct background structure feature in the preset scene may be used as the second interface image in the preset scene, thereby helping improve the accuracy in scene recognition of the first interface image.

In some embodiments, the second interface image in the preset scene may be obtained by clustering a plurality of video frame images.

In some embodiments, the operation in which a second interface image in the preset scene is obtained includes: a plurality of candidate video frame images are obtained, where the plurality of candidate video frame images include video frame images in a video obtained by recording the interface in the preset scene; the plurality of candidate video frame images are clustered, to obtain at least one cluster set; a cluster set meeting a preset feature condition of the preset scene is determined from the at least one cluster set; and the second interface image in the preset scene is selected from the video frame images in the determined cluster set.

The preset feature condition is a condition for judging whether the video frame image in the cluster set is in the preset scene according to the feature of the video frame image in the cluster set. The preset feature condition may be a feature possessed collectively by the interfaces in the preset scene in the background areas of the interfaces. The plurality of candidate video frame images may include second interface images of a plurality of scenes. The plurality of candidate video frame images are clustered. To be specific, the second interface images of different scenes may be clustered into various cluster sets. The second interface image in the preset scene is selected from the video frame images in the determined cluster set. The second interface image can be selected by any suitable techniques. In an example, a video frame image in which the degree of prominence of the background structure feature meets the preset screening condition may be selected.

In this embodiment, the video frame images recording the interfaces in the same scene may be clustered in a same cluster set by means of clustering, which is helpful to efficiently and accurately determine the second interface image in the preset scene, and to improve the accuracy in the scene recognition of the first interface image.

Operation 250: Extract a background structure feature of the second interface image in the second background area, to obtain the second background structure feature of the interface in the preset scene.

The process of extracting the background structure feature from the second background area is consistent with the process of extracting the first background structure feature from the first background area. Reference may be made to related content of extracting the second background structure feature from the second background area in the foregoing embodiment. The extracted background structure feature may be directly used as the second background structure feature of the interface in the preset scene, or the extracted background structure feature may be further processed, to obtain the second background structure feature of the interface in the preset scene. The further processing is, for example, normalization or aggregation.

In the foregoing embodiment, the background structure feature of the preset scene is extracted from the second interface image of the preset scene, to serve as a recognition criterion for the scene recognition of the preset scene, rather than directly using the second interface image of the preset scene as a template image. The template image may be applicable to images from different platforms and different models.

In some embodiments, when the background structure feature of the interface image is determined from the background area of the first interface image, area division may be performed on the first interface image, to extract the background structure feature of the interface image at a finer granularity.

In some embodiments, the foregoing operation 220 may include at least one operation of operation 221 to operation 223.

Operation 221: Perform area division on the first interface image to obtain a plurality of image areas.

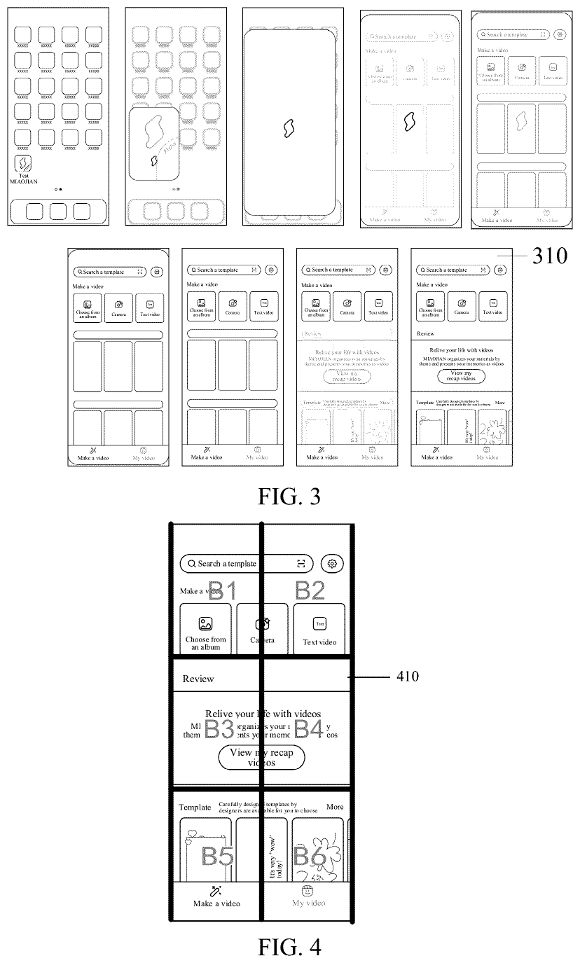

The granularity of area division for a first pair of interface images is not limited in this disclosure, and may be set according to an actual situation of the preset scene. For example, the first interface image may be divided into two image areas, or the interface image may alternatively be divided into six image areas. For example, as shown in FIG. 4, a first interface image 410 may be divided into six image areas (B1 to B6).

In some embodiments, various image areas may be uniformly divided, or may be nonuniformly divided. This is not limited in this disclosure.

In some embodiments, the granularity of area division for the first interface image is the same as a manner of area division for the second interface image. The foregoing area division manner may be understood as a position of each image area and a size ratio of the various image areas. For example, the second interface image is divided into two areas, and the area division manner refers to an area division ratio of the two areas. For example, if an area 1 and an area 2 are arranged one above the other, and a size ratio thereof is 1:1, the interface image is divided into two image areas, namely, an upper and lower image areas, in a same area division manner.

In some embodiments, the first interface image and the second interface image are different in size, but a size ratio of image areas of the first interface image is the same as a size ratio of image areas of the second interface image.

Operation 222: Determine an image area divided from a specified position in the first interface image from the plurality of image areas.

The specified position may be a preset position. In some embodiments, an interaction interface displaying a plurality of image areas obtained by dividing the first interface image may be provided for the user. The plurality of image areas in the interaction interface are arranged according to positions of the image areas in the first interface image. The specified position inputted by the user is determined, so as to determine the image area in the specified position from the plurality of image areas. The specified position inputted by the user may be determined in a manner such as a touch operation or a voice control manner, and is not limited.

In some embodiments, the image areas in the specified positions of the first interface image and the image areas in the specified positions of the second interface image are in a one-to-one correspondence. For example, as shown in FIG. 4, if an image area in the specified position of the second interface image is B3, the image area in the specified position of the first interface image is B3.

Operation 223: Obtain a background structure feature of the determined image area, to obtain the first background structure feature of the first interface image.

In some embodiments, a computer device may obtain an image area in at least one specified position in a plurality of image areas, determine a background structure feature of each image area in the at least one specified position from the background area of the image area in the at least one specified position, and then determine a first background structure feature of the first interface image according to the background structure feature of each image area in the at least one specified position.

In some embodiments, the operation of determining the first background structure feature of the first interface image according to the background structure feature of each image area in the at least one specified position may be specifically aggregating the background structure feature of each image area in the at least one specified position, to obtain the first background structure feature of the first interface image. The first background structure feature includes the background structure feature of each image area in the at least one specified position.

In some embodiments, the image area in the specified position may be set according to the background area of the second interface image. For example, the image area except the image area that is in the second interface image and has no intersection with the background area of the second interface image may be determined as the image area in the specified position. To be specific, the image area not including at least partial area of the background area in the second interface image is the image area in a non-specified position, and the image area including at least partial area of the background area in the second interface image is the image area in the specified position. Because the image area in the non-specified position does not include at least partial area of the background area of the preset scene, the background structure feature of the preset scene cannot be extracted from the non-specified image area. Therefore, the image area in the non-specified position does not need to be considered when the first background structure feature of the first interface image is determined.

Similarly, because the area division manner of the first interface image is the same as the area division manner of the second interface image, the image area in the specified position of the interface image is in the same position as the image area in the specified position of the second interface image, namely, the specified image area of the interface image and the specified image area of the second interface image are in a one-to-one correspondence.

According to the foregoing embodiment, the area division is performed on the first interface image, and the background structure feature of the image area in each specified position is extracted respectively as the first background structure feature of the first interface image, so that the fine-grained background structure feature of the first interface image may be extracted. Furthermore, only the background structure feature of the image area in the specified position is extracted, thereby reducing the workload required for processing the first interface image.

In some embodiments, the area division may further be performed on the first interface image in a plurality of different manners, to extract the background structure features of the first interface image at a plurality of granularities.

In some embodiments, the foregoing operation 220 may include at least one operation of operation 223 to operation 224.

Operation 223: Perform area division on the first interface image by using n different area division manners, to obtain n different area division results, where each area division result includes one or more image areas, and n is a positive integer.

In some embodiments, for the foregoing n different area division manners, quantities of the image areas in the area division results of the n different area division manners may be different.

For example, the area division result obtained in a first area division manner includes six image areas, and the area division result obtained in a second area division manner includes 36 image areas.

In some embodiments, for the foregoing n different area division manners, the image areas in the area division results obtained by the area division may alternatively be different in position or size.

For example, the area division result obtained in the first area division manner includes three image areas arranged top-to-bottom, and a size ratio of the image areas is 1:1:1; the area division result obtained in the second area division manner includes three image areas arranged from left to right, and a size ratio of the image areas is 1:1:1; the area division result obtained in a third area division manner includes three image areas arranged from left to right, and a size ratio of the image areas is 1:1:2; and the area division result obtained in a fourth area division manner includes three image areas arranged top-to-bottom, and a size ratio of the image areas is 1:1:2.

In some embodiments, different area division manners correspond to different area division results, and each area division result includes one or more image areas. For example, as shown in FIG. 4, the area division result corresponding to the first area division manner includes one image area A1, the area division result corresponding to the second area division manner includes six image areas B1 to B6, and the area division result corresponding to the third area division manner includes thirty-six image areas C01 to C36 in total.

Operation 224: Aggregate the background structure features respectively corresponding to the n area division results, to obtain the first background structure feature of the first interface image.

The computer device may aggregate the background structure features respectively corresponding to the n area division results, to obtain the first background structure feature of the first interface image. Aggregating the background structure features respectively corresponding to the n area division results may be combining the background structure features respectively corresponding to the n area division results, to obtain the first background structure feature of the first interface image, where the first background structure feature includes the background structure features respectively corresponding to the n area division results. The background structure features respectively corresponding to the n area division results may alternatively be combined as the first background structure feature of the first interface image.

In some embodiments, the operation in which the background structure feature is determined respectively for each area division result of the n area division results to obtain the first background structure feature of the first interface image includes: For an i^{th} area division result of the n area division results, the background structure feature (also referred to as divisional background structure feature) of at least one specified image area in the i^{th} area division result, to obtain the background structure feature corresponding to the i^{th} area division result, where i is an integer less than or equal to n; and The background structure features respectively corresponding to the n area division results are aggregated, to obtain the first background structure feature of the first interface image.

In some embodiments, some of the n area division results may include the image area in the specified position, and the remaining area division results may not include the image area in the specified position. For example, as shown in FIG. 5, the specified image areas are A1, C10, C11, C30, and C31. To be specific, the area division result corresponding to the second area division manner does not include the image area in the specified position, and the area division results corresponding to the first area division manner and the third area division manner include the image areas in the specified positions. In this embodiment, different area division manners can represent a feature of a background structure in the first interface image from different perspectives, and the background structure features respectively corresponding to the n area division results are aggregated to obtain the first background structure feature of the first interface image, which can express richer information, facilitating more accurate scene recognition.

According to the foregoing embodiment, the first background structure feature of the first interface image is determined based on the n area division results, and the background structure feature of the first interface image at various granularities is considered, so that the first background structure feature of the first interface image can better describe the background structure of the first interface image, thereby improving the accuracy in the scene recognition of the application program.

In some embodiments, an image analysis algorithm may be used for determining the background structure feature of the interface image. The image analysis algorithm is used for describing a structure of a background area of an image. The specific image analysis algorithm is not limited in this disclosure. Several related methods for determining the background structure feature of the interface image are exemplarily described below.

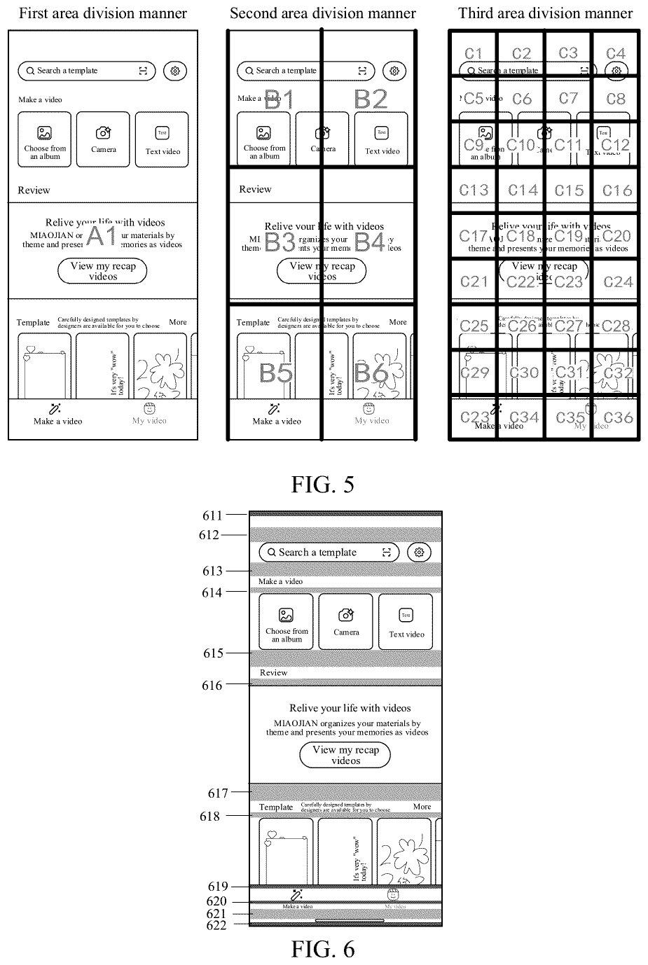

In some embodiments, the first background structure feature includes at least one of a color of at least one through line in the first background area, a quantity of the at least one through line, a position of the at least one through line, a color of a subarea of at least one specified position, or brightness of the subarea of the at least one specified position. The through line extends through the interface or extends through a specified area in the interface along a direction. The through line may have a line width, and visually seems to be a rectangle or a rectangle with rounded corners. The subarea is partial area included in the interface, such as an image area displaying an image or a text area displaying text. For example, as shown in FIG. 6, the through lines 611 to 622 extend through the interface.

In some embodiments, the through lines may be expressed in different colors according to a width (or a height). For example, the through line whose width (or height) exceeds a threshold may be expressed in a first color. The through line whose width (or height) does not exceed the threshold may be expressed in a second color. The first color is different from the second color. For example, the first color may be green, and the second color may be red. For example, as shown in FIG. 6, widths of all the through lines 611, 618, 619, and 622 do not exceed the threshold, and accordingly the through lines are represented in the second color; and widths of all the through lines 612 to 617, and 621 exceed the threshold, and accordingly the through lines are represented in the first color. The foregoing threshold is not limited in this disclosure, and may be set according to the preset scene.

In some embodiments, the foregoing through lines may include a horizontal through line and a longitudinal through line. Through lines 611 to 622 shown in FIG. 6 are all horizontal through lines.

In some embodiments, the first background structure feature includes at least one of the following: a color of at least one horizontal through line in the first background area; a quantity of the at least one horizontal through line in the first background area; a position of the at least one horizontal through line in the first background area; a color of at least one longitudinal through line in the first background area; a quantity of the at least one longitudinal through line in the first background area; and a position of the at least one longitudinal through line in the first background area.

In some embodiments, the subarea in the specified position may be formed by one or more pixels in the interface image.

In some embodiments, the first background structure feature may include a combination of a plurality of background result features. For example, the first background structure feature may include at least one of the following: a quantity of at least one same-color through line in the first background area; a position of the at least one same-color through line in the first background area; a quantity and position of the at least one same-color through line in the first background area; and a color and brightness of a subarea of at least one specified position in the first background area.

Certainly, other combinations may alternatively exist, and are not listed one by one herein in this disclosure.

By using the foregoing method, the first background structure feature of the first interface image is represented in a simple manner, thereby avoiding complex feature extraction operations, improving the determination speed of the background structure feature of the interface image, and further improving the scene recognition speed of the application program.

In some embodiments, the foregoing scene recognition method of the application program further includes: a first interface image recording an interface of an application program in a preset scene is obtained, to obtain a to-be-evaluated interface image set; and a running condition of the application program is evaluated based on the first interface image in the to-be-evaluated interface image set, to obtain a running evaluation result of the application program.

In this embodiment, a first video obtained by recording the interface of the application program is first obtained. Recorded content of the first video may be adjusted according to an application scene for performing running evaluation on the application program. For example, if startup performance of the application program is to be evaluated, the first video includes a startup process of the application program. For example, the first video includes an entire process from a moment when a user clicks the application program to a moment when a startup interface of the application program is displayed.

Further, the first video may be framed, to obtain a plurality of video frame images. During the framing, the first video may be evenly framed according to a first time interval. To be specific, a time interval between every two adjacent video frames is the same.

A specific duration of the first time interval is not limited in this disclosure. For example, the first time interval may be as small as possible within a particular range, to ensure time accuracy. For another example, the first time interval may be as large as possible within a particular range, to reduce a quantity of video frame images obtained by framing. The particular range does not affect the accuracy in scene recognition of the application program.

In some embodiments, the duration of the first time interval may be adjusted according to the application scene for performing running evaluation on the application program, or may be changed according to the duration of the first video. This is not limited in this application. For example, if the duration of the first video is relatively long, the duration of the first time interval is also relatively long. If the duration of the first video is short, the duration of the first time interval is also relatively short.

Further, refer to operation 210 to operation 230 and related operations. The computer device may traverse the plurality of video frame images, and use each traversed video frame image as the first interface image. The first interface image includes a first interface element area in which a preset interface element of the application program is located, and further includes a first background area except the first interface element area.

The computer device may determine a first background structure feature of the first interface image in the first background area; obtain a second background structure feature of the interface in a preset scene; and determine whether the first background structure feature and the second background structure feature meet a preset matching condition.

When the first background structure feature and the second background structure feature meet the preset matching condition, it is determined that the interface recorded in the first interface image is in the preset scene. When it is determined that the interface recorded in the first interface image is in the preset scene, the first interface image is added to the to-be-evaluated interface image set, and then the traversing is performed until all images are traversed. A running condition of the application program is evaluated based on the first interface image in the to-be-evaluated interface image set, to obtain a running evaluation result of the application program.

The running condition of the application program may include at least one of the following: a startup condition of the application program, and an instruction response condition of the application program. The startup condition of the application program may refer to a duration required for starting the application program. An example in which the duration for starting the application program is evaluated is used, and a scene needing to be evaluated includes the preset scene: a selection interface of the application program (such as a mobile phone desktop or a computer desktop), and a startup interface of the application program (i.e. an interface displayed when the application program is started, such as a home page of the application program). In some embodiments, the preset scene includes a first sub-scene and a second sub-scene, the first sub-scene is a scene in which the selection interface of the application program is located, and the second sub-scene is a scene in which the startup interface of the application program is located.

In this case, the duration required for starting the application program may be determined only by determining a time interval between the last video frame image in the interface video frame image corresponding to the first sub-scene and the first video frame image in the interface video frame image corresponding to the second sub-scene, and the time interval is determined as the running evaluation result of the application program.

The instruction response condition of the application program may include a condition whether the application program responds to an instruction. In view of this, the method may be applied to an automated test of the application program. The automated test of the application program is taken as an example, and the scene needing to be evaluated includes the preset scene: an instruction response interface of the application program.

In some embodiments, the preset scene is a scene in which the instruction response interface of the application program is located. A test process of the application program includes a process between the transmission of an instruction to the application program and the corresponding response of the application program to the instruction, and the process may be fully automated based on an automated test technology.

In this case, if the preset scene is not recognized in a plurality of video frame images of the first video, the application program does not respond to the instruction, and the application program has a problem. If the preset scene is recognized in any video frame image of the first video, the application program responds to the instruction, and there is no problem in the application program. Therefore, whether the preset scene is recognized in the video frame image of the first video may be determined as the running evaluation result of the application program.

Certainly, in the test process of the application program, a plurality of scenes may alternatively be recognized for a plurality of instructions. For example, a first instruction corresponds to a scene 1, and a second instruction corresponds to a scene 2. Therefore, in an evaluation process, the scene 1 and the scene 2 may be separately recognized.

In some embodiments, the scene recognition method of the application program provided in this embodiment of this disclosure may further be applied to evaluation on speed type indexes (or referred to as speed analysis tasks) of a terminal, such as a startup speed of the application program and an instruction response speed of the application program. The method may alternatively be applied to an automated assertion, such as an automated test. Certainly, the method may alternatively be applied to another scene requiring the scene recognition, for example, recognizing whether an image belongs to a grassland scene. This is not limited in this disclosure.

According to the technical solutions provided in the embodiments of this disclosure, the video recording the interface of the application program is framed, to obtain a plurality of video frame images, the interfaces in the plurality of video frame images are recognized, and whether the plurality of video frame images include the video frame image of the interface belonging to the interface of the preset scene is determined, so as to implement the running evaluation on the application program, thereby achieving full automation of the running evaluation process of the application program.

In conclusion, this embodiment of this disclosure provides the scene recognition method of the application program. The scene recognition method may be used in the running evaluation of the application program, to achieve the full automation of the running evaluation process of the application program.

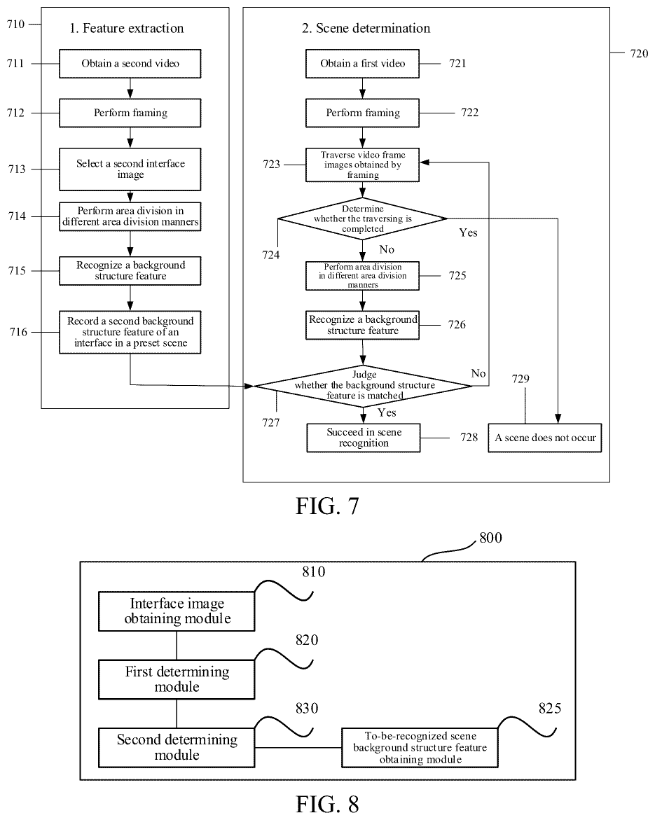

For example, as shown in FIG. 7, the technical solution provided in this embodiment of this disclosure may include the following two sections: Feature extraction 710 and scene determination 720.

### 1. Feature Extraction

A second video is obtained (711). The second video is framed to obtain a video frame image (712). A starting video frame image in which the preset scene occurs is selected from the second video; and The starting video frame image is used as a second interface image in the preset scene (713). Area division is performed on the second interface image by using n different area division manners, to obtain n different area division results, where each area division result includes one or more image areas, and n is a positive integer (714). A background structure feature is determined respectively for each area division result of the n area division results (715). The background structure feature determined from each area division result is screened and aggregated to obtain a second background structure feature of the interface in the preset scene (716).

During the framing in operation 712, in addition to splitting the second video into a plurality of video frame images, if running evaluation performed on the application program includes speed analysis, uniform framing is used, so as to ensure that inter-frame time is fixed, and a framing interval needs to be short to ensure accuracy.

Operation 714: Perform area division by layering: For example, as shown in FIG. 6, the area division is performed on the second interface image in three area division manners. Layering means that the area division is performed on the second interface image at different granularities. The layering area division does not limit a quantity of layers (i.e. a quantity of different area division manners) and a quantity of divided areas (i.e., a quantity of image areas included in an area division result obtained in one area division manner), provided that feature description can be effectively performed (namely, a structure of a background of the second interface image can be effectively described). As shown in FIG. 6, core feature areas (specified image areas) A1, C10, C11, C30, and C31 of the preset scene can be found by using three layers.

Operation 715: Recognize a background structure feature. This section may be used as long as the method effectively describes the structure of the background of the second interface image. In some examples, a same-color through line, such as shown in FIG. 5, can be used.

The same-color through lines are generally divided into horizontal and longitudinal through lines and defined by a width or height threshold. The same-color through line whose width or height does not reach the threshold needs to be deleted. Similar calculation is performed on each image area (namely, the same-color through lines are determined), to obtain the background structure features (the background structure features represented by using the same-color through lines) of all the image areas.

Operation 716: Extract and record a main background structure feature, and obtain a second background structure feature of the interface in the preset scene. The second background structure feature of the second interface image shown in FIG. 5 includes: A1 is horizontally run through by 8 and longitudinally run through by 0, C10 is longitudinally run through by 1, C11 is longitudinally run through by 1, C30 is longitudinally run through by 1, and C31 is longitudinally run through by 1.

### 2. Scene Determination

A first video obtained by recording an interface of an application program is obtained (721). The first video is framed according to a first time interval, to obtain a plurality of video frame images (722). For any video frame image of the plurality of video frame images, a background structure feature of the video frame image is determined (723). Whether the traversing is completed is determined (724). If not, the area division is performed on the first interface image by using n different area division manners to obtain n different area division results, where each area division result includes one or more image areas, and n is a positive integer (725). A background structure feature is determined respectively for each area division result of the n area division results (726). Whether the first background structure feature and the second background structure feature meet a preset matching condition is determined (727). When the first background structure feature and the second background structure feature meet a preset matching condition, it is determined that the interface recorded in the first interface image is in the preset scene, namely, the scene recognition succeeds (728). If the preset scene is not recognized from any video frame image, the scene does not occur (729).

For all operations involved in the scene determination, refer to the method of operations in feature extraction, and details are not repeated in this disclosure.

According to the technical solution provided in this embodiment of this disclosure, after the second background structure feature of the interface in the preset scene is determined, the first background structure feature of the first interface image is matched with the foregoing second background structure feature, to implement the scene recognition of the application program. The processing is performed based on a simple image analysis algorithm without complex feature extraction operations, so that time required for the scene recognition of the application program is reduced. A good effect may further be achieved for the complex scene analysis. In addition, the scene recognition based on the background structure feature may be applicable to images obtained by different platforms and different models.

The following describes apparatus embodiments of this disclosure, which may be used for executing the method embodiments of this disclosure. For details not disclosed in the apparatus embodiments of this disclosure, refer to the method embodiments of this disclosure.

FIG. 8 is a block diagram of a scene recognition apparatus of an application program according to an embodiment of this disclosure. The apparatus has a function of implementing the foregoing method examples. The function may be implemented by hardware or by hardware executing corresponding software. The apparatus may be the foregoing computer device, or may be disposed in the computer device. As shown in FIG. 8, the apparatus 800 includes: an interface image obtaining module 810, a first determining module 820, a preset scene background structure feature obtaining module 825, and a second determining module 830.

The interface image obtaining module 810 is configured to obtain a first video obtained by recording an interface of an application program; and extract a first interface image from the first video, the first interface image including a first interface element area in which a preset interface element of the application program is located and further including a first background area except the first interface element area.

The first determining module 820 is configured to determine a first background structure feature of the first interface image in the first background area.

The preset scene background structure feature obtaining module 825 is configured to obtain a second background structure feature of the interface in the preset scene.

The second determining module 830 is configured to judge whether the first background structure feature and the second background structure feature meet a preset matching condition; and determine that the interface recorded in the first interface image is in the preset scene when the first background structure feature and the second background structure feature meet the preset matching condition.

In some embodiments, the first determining module 820 is configured to perform area division on the first interface image to obtain a plurality of image areas; determine an image area divided from a specified position in the first interface image from the plurality of image areas; and obtain a background structure feature of the determined image area, to obtain the first background structure feature of the first interface image.

In some embodiments, the first determining module 820 is configured to perform area division on the first interface image by using n different area division manners, to obtain n different area division results, each area division result including one or more image areas, and n being a positive integer; and determine a background structure feature respectively for each area division result of the n area division results, to obtain the first background structure feature of the first interface image.

In some embodiments, the first determining module 820 is configured to: for an i^{th} area division result of the n area division results, obtain a background structure feature of at least one specified image area in the i^{th} area division result, to obtain the background structure feature corresponding to the i^{th} area division result, i being an integer less than or equal to n; and aggregate the background structure features respectively corresponding to the n area division results, to obtain the first background structure feature of the first interface image.

In some embodiments, the first background structure feature includes at least one of a color of at least one through line in the first background area, a quantity of the at least one through line, a position of the at least one through line, a color of a subarea of at least one specified position, or brightness of the subarea of the at least one specified position.

In some embodiments, the matching condition is that the first background structure feature and the second background structure feature are the same.

In some embodiments, as shown in FIG. 9, the apparatus 800 further includes a third determining module 840.

The third determining module 840 is configured to binarize the first interface image, to obtain a binary image; extract a contour of the binary image to obtain a contour image; determine a contour of the preset interface element in the contour image; and determine the first background area except the preset interface element in the first interface image according to the contour of the preset interface element in the contour image.

In some embodiments, as shown in FIG. 9, the apparatus 800 further includes a fourth determining module 850.

The fourth determining module 850 is configured to obtain a first interface image recording the interface of the application program in the preset scene, to obtain a to-be-evaluated interface image set; and evaluate a running condition of the application program based on the first interface image in the to-be-evaluated interface image set, to obtain a running evaluation result of the application program.

In some embodiments, as shown in FIG. 9, the apparatus 800 further includes a preset scene background structure feature obtaining module 860.

The preset scene background structure feature obtaining module 860 is configured to obtain a second interface image in the preset scene, the second interface image including a second interface element area in which the preset interface element of the application program is located, and further including a second background area except the second interface element area; and extract a background structure feature of the second interface image in the second background area, to obtain a second background structure feature of the interface in the preset scene.

In some embodiments, the preset scene background structure feature obtaining module 860 is configured to obtain a second video obtained by recording the interface of the application program in the preset scene. select a starting video frame image in which the preset scene occurs from the second video; and use the starting video frame image as the second interface image in the preset scene.

In some embodiments, the preset scene background structure feature obtaining module 860 is configured to obtain a plurality of candidate video frame images, the plurality of candidate video frame images including video frame images in a video obtained by recording the interface in the preset scene. perform clustering on the plurality of candidate video frame images to obtain at least one cluster set; determine a cluster set meeting a preset feature condition of the preset scene from the at least one cluster set; and select the second interface image in the preset scene from the video frame images in the determined cluster set.

According to the technical solution provided in this embodiment of this disclosure, the background structure feature of the interface image is extracted in the background area of the interface image, and feature matching detection is performed on the background structure feature of the interface image and the background structure feature of the preset scene, to determine whether the interface element area belongs to the interface of the preset scene. The processing is performed based on a simple image analysis algorithm without complex feature extraction operations, so that time required for the scene recognition of the application program is reduced. A good effect may further be achieved for complex scene analysis. In addition, the scene recognition based on the background structure feature may be applicable to images obtained by different platforms and different models.

In addition, when the apparatus provided in the foregoing embodiment implements functions of the apparatus, it is illustrated with an example of division of each functional module. In the practical application, the function distribution may be finished by different functional modules according to the actual requirements, namely, the internal structure of the device is divided into different functional modules, to implement all or some of the functions described above.

Specific operation execution manners of the modules in the apparatus in the foregoing embodiment have been described in detail in the embodiments about the method, and details will not be described herein again.

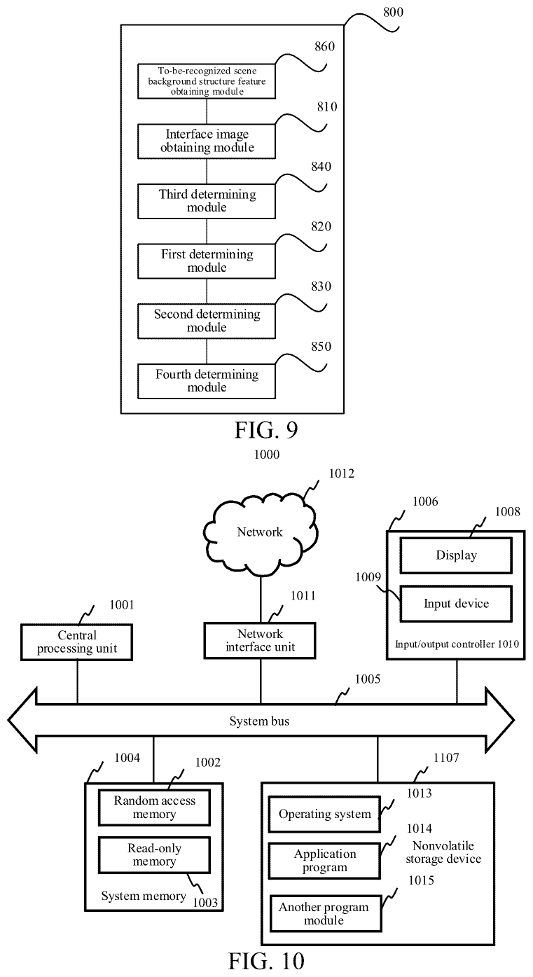

FIG. 10 is a schematic structural diagram of a computer device according to an embodiment of this disclosure. The computer device may be any electronic device having data computing, processing, and storage functions. The computer device may be configured to implement the scene recognition method of the application program provided in the foregoing embodiments. Specifically, as follows:

The computer device 1000 includes a central processing unit (for example, a CPU, a graphics processing unit (GPU), and a field programmable gate array (FPGA)) 1001, a system memory 1004 including a random access memory (RAM) 1002 and a read-only memory (ROM) 1003, and a system bus 1005 connecting the system memory 1004 and the CPU 1001. The computer device 1000 further includes a basic input/output (I/O) system 1006 helping transmit information between components in a server and a nonvolatile storage device 1007 configured to store an operating system 1013, an application program 1014, and another program module 1015.

In some embodiments, the basic I/O system 1006 includes a display 1008 configured to display information and an input device 1009, such as a mouse or a keyboard, configured to input information by a user. The display 1008 and the input device 1009 are both connected to the CPU 1001 by using an input/output controller 1010 connected to the system bus 1005. The basic I/O system 1006 may further include the input/output controller 1010 to be configured to receive and process inputs from a plurality of other devices such as a keyboard, a mouse, or an electronic stylus. Similarly, the input/output controller 1010 further provides an output to a display screen, a printer, or another type of output device.

The nonvolatile storage device 1007 is connected to the CPU 1001 by using a storage controller (not shown) connected to the system bus 1005. The nonvolatile storage device 1007 and an associated computer-readable medium provide non-volatile storage for the computer device 1000. To be specific, the nonvolatile storage device 1007 may include a computer-readable medium (not shown) such as a hard disk or a compact disc read-only memory (CD-ROM) drive.

Generally, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, an erasable programmable ROM (EPROM), an electrically erasable programmable ROM (EEPROM), a flash memory or another solid-state memory technology, a CD-ROM, a digital video disc (DVD) or another optical memory, a tape cartridge, a magnetic tape, a magnetic disk memory, or another magnetic storage device. Certainly, a person skilled in art can learn that the computer storage medium is not limited to the foregoing several types. The system memory 1004 and the nonvolatile storage device 1007 may be collectively referred to as a memory.

According to the embodiments of this disclosure, the computer device 1000 may further be connected, through a network such as the Internet, to a remote computer on the network and run. To be specific, the computer device 1000 may be connected to a network 1012 by using a network interface unit 1011 connected to the system bus 1005, or may be connected to another type of network or a remote computer system (not shown) by using the network interface unit 1011.

The memory further includes a computer program. The computer program is stored in the memory and is configured to be executed by one or more processors to implement the foregoing scene recognition method of the application program.

In an exemplary embodiment, a computer-readable storage medium is further provided. The storage medium has a computer program stored therein, and the computer program, when executed by a processor of a computer device, implements the foregoing scene recognition method of the application program.

In some embodiments, the computer-readable storage medium may include: a read-only memory (ROM), a random-access memory (RAM), a solid state drive (SSD), an optical disc, or the like. The RAM may include a resistance random access memory (ReRAM) and a dynamic random access memory (DRAM).

In an exemplary embodiment, a computer program is further provided. The computer program includes computer instructions stored in a computer-readable storage medium. A processor of a computer device reads the computer instructions from the computer-readable storage medium, and executes the computer instructions, to cause the computer device to perform the foregoing scene recognition method of the application program.

In addition, in this disclosure, a prompt interface or a pop-up window can be displayed, or voice prompt information can be outputted before collecting user-related data and when collecting user-related data. The prompt interface, the pop-up window, or the voice prompt information is configured for prompting the user that user-related data is currently being collected. In this way, in this disclosure, related steps of obtaining the user-related data only start to be executed after obtaining a confirmation operation of the user on the prompt interface or the pop-up window. Otherwise (that is, the confirmation operation of the user on the prompt interface or the pop-up window is not obtained), the related steps of obtaining the user-related data are ended, that is, the user-related data is not obtained. In other words, all user data (including title information of an online meeting and a user account) collected by this disclosure is processed strictly in accordance with the requirements of relevant national laws and regulations. The informed consent or separate consent of a personal information subject is collected with the consent and authorization of the user, subsequent data use and processing activities are carried out within the scope of laws, regulations and the authorization of the personal information subject, and the collection, use and processing of user-related data need to comply with relevant laws, regulations and standards of relevant countries and regions.

“Plurality of” mentioned in the specification means two or more. “And/or” describes an association relationship for describing associated objects, and represents that three relationships may exist. For example, A and/or B may represent the following three cases: only A exists, both A and B exist, and only B exists. The character “/” in this specification generally indicates an “or” relationship between the associated objects.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Technical features of the foregoing embodiments may be suitably combined. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of this disclosure, which are described specifically and in detail, but cannot be construed as a limitation to the patent scope of this disclosure. It should be noted that for a person of ordinary skill in the art, several transformations and improvements can be made without departing from the idea of this disclosure. These transformations and improvements belong to the protection scope of this disclosure. Therefore, the protection scope of the patent of this disclosure shall be subject to the appended claims.

What is claimed is:

1. A method of scene recognition, the method comprising:
obtaining a first video that includes interface images of a computer device that are recorded when an application program is executed on the computer device;
extracting a first interface image from the first video, the first interface image comprising a first interface element area with one or more preset interface elements of the application program, and a first background area excluding the first interface element area;
determining a first background structure feature of the first background area in the first interface image;
determining whether the first background structure feature satisfies a matching condition to a second background structure feature of a preset scene; and
determining that the first interface image corresponds to the preset scene when the first background structure feature satisfies the matching condition to the second background structure feature.

2. The method according to claim 1, wherein the determining the first background structure feature comprises:
dividing the first interface image into a plurality of image areas;
determining a specific image area from the plurality of image areas according to a specific position in the first interface image; and
obtaining the first background structure feature of the first interface image based on one or more structure features of the specific image area.

3. The method according to claim 1, wherein the determining the first background structure feature comprises:
performing area divisions on the first interface image respectively according to n area division manners, to obtain n respective area division results, the n area division manners being different from each other, an area division result according to an area division manner of the n area division manners comprising respective one or more image areas that are divided from the first interface image using the area division manner, and n being a positive integer;
determining respective background structure features of the n respective area division results; and
obtaining the first background structure feature of the first interface image based on the respective background structure features.

4. The method according to claim 3, wherein:
the determining the respective background structure features comprises:
for an i^{th} area division result of the n respective area division results, obtaining a respective background structure feature corresponding to the i^{th} area division result based on a divisional background feature of at least one specified image area in the respective one or more image areas of the i^{th} area division result, i being an integer less than or equal to n; and
the obtaining the first background structure feature comprises:
aggregating the respective background structure features of the n respective area division results, to obtain the first background structure feature of the first interface image.

5. The method according to claim 1, wherein the first background structure feature comprises at least one of:
a color of at least one through line in the first background area,
a quantity of the at least one through line,
a position of the at least one through line,
a color of a subarea of at least one specified position, and/or
a brightness of a subarea of the at least one specified position.

6. The method according to claim 1, wherein the matching condition specifies that the first background structure feature is identical to the second background structure feature.

7. The method according to claim 1, the method further comprising:
binarizing the first interface image, to obtain a binary image;
extracting a contour image of the binary image;
determining a contour of the one or more preset interface elements in the contour image; and
determining the first background area that excludes the one or more preset interface elements in the first interface image according to the contour of the one or more preset interface elements in the contour image.

8. The method according to claim 1, the method further comprising:
recognizing the one or more preset interface elements in the first interface image; and
determining an area that excludes the one or more preset interface elements in the first interface image as the first background area of the first interface image.

9. The method according to claim 1, the method further comprising:
obtaining a to-be-evaluated interface image set, the to-be-evaluated interface image set comprising the first interface image that is recorded to represent a running condition of the application program in the preset scene; and
evaluating the running condition of the application program based on the first interface image in the to-be-evaluated interface image set, to obtain a running evaluation result of the application program.

10. The method according to claim 1, the method further comprising:
obtaining a second interface image that represents a standard execution of the application program in the preset scene, the second interface image comprising a second interface element area with the one or more preset interface elements of the application program, and a second background area excluding the second interface element area;
extracting a background structure feature of the second background area; and
obtaining the second background structure feature of the preset scene based on the background structure feature of the second background area.

11. The method according to claim 10, wherein the obtaining the second interface image comprises:
obtaining a second video that includes second interface images that are recorded when the standard execution of the application program in the preset scene occurs;
selecting a starting video frame image of the preset scene from the second video; and
using the starting video frame image as the second interface image of the preset scene.

12. The method according to claim 10, wherein the obtaining the second interface image comprises:
obtaining a plurality of candidate video frame images, the plurality of candidate video frame images comprising recorded interface images of a plurality of scenes;
clustering the plurality of candidate video frame images to obtain one or more cluster sets;
determining a cluster set from the one or more cluster sets that satisfies a preset feature condition of the preset scene; and
selecting the second interface image of the preset scene from the determined cluster set.

13. An information processing apparatus, comprising processing circuitry configured to:
obtain a first video that includes interface images of a computer device that are recorded when an application program is executed on the computer device;
extract a first interface image from the first video, the first interface image comprising a first interface element area with one or more preset interface elements of the application program, and a first background area excluding the first interface element area;
determine a first background structure feature of the first background area in the first interface image;
determine whether the first background structure feature satisfies a matching condition to a second background structure feature of a preset scene; and
determine that the first interface image corresponds to the preset scene when the first background structure feature satisfies the matching condition to the second background structure feature.

14. The apparatus according to claim 13, wherein the processing circuitry is configured to:
divide the first interface image into a plurality of image areas;
determine a specific image area from the plurality of image areas according to a specific position in the first interface image; and
obtain the first background structure feature of the first interface image based on one or more structure features of the specific image area.

15. The apparatus according to claim 13, wherein the processing circuitry is configured to:
perform area divisions on the first interface image respectively according to n area division manners, to obtain n respective area division results, the n area division manners being different from each other, an area division result according to an area division manner of the n area division manners comprising respective one or more image areas that are divided from the first interface image using the area division manner, and n being a positive integer;
determine respective background structure features of the n respective area division results; and
obtain the first background structure feature of the first interface image based on the respective background structure features.

16. The apparatus according to claim 15, wherein the processing circuitry is configured to:
for an i^{th} area division result of the n respective area division results, obtain a respective background structure feature corresponding to the i^{th} area division result based on a divisional background feature of at least one specified image area in the respective one or more image areas of the i^{th} area division result, i being an integer less than or equal to n; and
aggregate the respective background structure features of the n respective area division results, to obtain the first background structure feature of the first interface image.

17. The apparatus according to claim 13, wherein the first background structure feature comprises at least one of:
a color of at least one through line in the first background area,
a quantity of the at least one through line,
a position of the at least one through line,
a color of a subarea of at least one specified position, and/or
a brightness of a subarea of the at least one specified position.

18. The apparatus according to claim 13, wherein the matching condition specifies that the first background structure feature is identical to the second background structure feature.

19. The apparatus according to claim 13, wherein the processing circuitry is configured to:
binarize the first interface image, to obtain a binary image;
extract a contour image of the binary image;
determine a contour of the one or more preset interface elements in the contour image; and
determine the first background area that excludes the one or more preset interface elements in the first interface image according to the contour of the one or more preset interface elements in the contour image.

20. A non-transitory computer-readable storage medium storing instructions which when executed by at least one processor cause the at least one processor to perform:
obtaining a first video that includes interface images of a computer device that are recorded when an application program is executed on the computer device;
extracting a first interface image from the first video, the first interface image comprising a first interface element area with one or more preset interface elements of the application program, and a first background area excluding the first interface element area;
determining a first background structure feature of the first background area in the first interface image;
determining whether the first background structure feature satisfies a matching condition to a second background structure feature of a preset scene; and
determining that the first interface image corresponds to the preset scene when the first background structure feature satisfies the matching condition to the second background structure feature.
